(19) United States
(12) Patent Application Publication
(10) Pub. No.: US 2007/0083521 A1
(43) Pub. Date: Apr. 12, 2007

(54) Routing requests based on synchronization levels

(75) Inventors: Richard Alan Diedrich, Rochester, MN (US); Jinmei Shen, Rochester, MN (US); Hao Wang, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/246,821

(22) Filed: Oct. 7, 2005

(51) Int. Cl. G06F 17/30

(52) U.S. Cl. 707/10

(57) ABSTRACT

A method, apparatus, system, and signal-bearing medium that, in an embodiment, route requests to servers based on a synchronization level of data that the servers provide. In an embodiment, synchronization levels that servers provide are determined, a synchronization level that a request requires is determined, a server is selected based on the provided synchronization levels and the required synchronization level, and the request is routed to the selected server. The selection of the server may include selecting a subset of the servers, ordering the subset based on the provided synchronization levels, and selecting the highest synchronization level that is processing less than a threshold number of requests. In various embodiments, the provided synchronization levels are determined based on probabilities that data changes are synchronized between the servers based on distributions of propagation time delays of data changes between the servers, based on distributions of elapsed times between data changes, and based on both distributions.

### FIELD

An embodiment of the invention generally relates to computers. In particular, an embodiment of the invention generally relates to routing requests to servers based on synchronization levels of data.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs. As advances in semiconductor processing and computer architecture push the performance of the computer hardware higher, more sophisticated and complex computer software has evolved to take advantage of the higher performance of the hardware, resulting in computer systems today that are much more powerful than just a few years ago.

Years ago, computers were stand-alone devices that did not communicate with each other, but today, computers are increasingly connected in networks and one computer, called a client, may request another computer, called a server, to perform an operation. With the advent of the Internet, this client/server model is increasingly being used in online businesses and services, such as online auction houses, stock trading, banking, commerce, and information storage and retrieval.

In order to provide enhanced performance, reliability, and the ability to respond to a variable rate of requests from clients, companies often use multiple servers to respond to requests from clients and replicate their data across the multiple servers. For example, an online clothing online store may have several servers, each of which may include replicated inventory data regarding the clothes that are in stock and available for sale. A common problem with replicated data is keeping the replicated data on different servers synchronized. For example, if a client buys a blue shirt via a request to one server, the inventory data at that server is easily decremented, in order to reflect that the number of blue shirts in stock has decreased by one. But, the inventory data for blue shirts at the other servers is now out-of-date or “stale” and also needs to be decremented, in order to keep the replicated data across all servers synchronized and up-to-date.

One current technique for handling stale data is to lock the stale data, which prevents subsequent requests from accessing the stale data until it has been synchronized with other servers. This locking technique adversely affects the performance of subsequent requests since they must wait until the data has been synchronized and the lock has been released. For some data and some clients, completely current data is essential. For example, a banking application that transfers money between accounts requires financial data that is completely current. In contrast, a customer who merely wants to order one blue shirt does not care whether the online clothing store currently has 100 blue shirts in stock or only 99. Such a customer might gladly opt to access data that is slightly out-of-date if performance would improve. Unfortunately, the aforementioned locking technique ignores the preferences and tolerance of the client for stale data and always locks the data.

Locking stale data also treats all data and all data requests the same, despite the fact that different requests may have different needs for current data and different data may have different characteristics that impact the data's currency, i.e., the importance of whether the data is current or stale. For example, a news service might have categories of headline news and general news with the headline news being updated hourly while general news is only updated daily. But, a brokerage firm may need to update stock prices every second. Thus, the importance of accessing current data for stock prices may be higher than the importance of accessing current data for general news. Yet, even for stock price data, the needs for current data may vary between requests. For example, a request that merely monitors stock prices may have less of a need for current data than a request for a transaction, such as buying or selling stock. Since the number of requests to monitor data is far greater than the number of requests for transactions, providing the same level of current data may be an inefficient use of resources.

Locking stale data also ignores the performance implications of propagation delays between servers, which can impact the data's currency. High availability requires customers to replicate their data, and disaster recovery requires customers to locate their data centers far away from each other to avoid regional disasters such as hurricane, flood, forest fire, earthquake, or tornado. But, the longer the distance between the servers, the longer the delay in propagating the data between the servers. But, the possibility of these disasters is small, therefore, most high availability and disaster recovery data centers are unused during normal operation, without participating in the servicing of client requests.

Thus, a better technique is needed to handle replicated data in multiple servers.

### SUMMARY

A method, apparatus, system, and signal-bearing medium are provided that, in an embodiment, route requests to servers based on a synchronization level of data that the servers provide. In an embodiment, synchronization levels that servers provide are determined, a synchronization level that a request requires is determined, a server is selected based on the provided synchronization levels and the required synchronization level, and the request is routed to the selected server. The selection of the server may include selecting a subset of the servers, ordering the subset based on the provided synchronization levels, and selecting the highest synchronization level that is processing less than a threshold number of requests. In various embodiments, the provided synchronization levels are determined based on probabilities that data changes are synchronized between the servers based on distributions of propagation time delays of data changes between the servers, based on distributions of elapsed times between data changes, and based on both distributions. In this way, the risk of the clients receiving stale data is reduced, waiting on locks is avoided, and higher availability and better response time are provided.

### BRIEF DESCRIPTION OF THE DRAWING

Various embodiments of the present invention are hereinafter described in conjunction with the appended drawings:

FIG. 1 depicts a block diagram of an example system for implementing an embodiment of the invention.

FIG. 2 depicts a block diagram of selected components of the example system, according to an embodiment of the invention.

FIG. 3 depicts a block diagram of selected components of a guarantee table, according to an embodiment of the invention.

FIG. 4A depicts a flowchart of example processing at a client for initiating a request, according to an embodiment of the invention.

FIG. 4B depicts a flowchart of further example processing at a client for initiating a request, according to an embodiment of the invention.

FIG. 5 depicts a flowchart of example processing at a client for routing a request to a server and processing a response, according to an embodiment of the invention.

FIG. 6 depicts a flowchart of example processing at a server for processing a request, according to an embodiment of the invention.

FIG. 7 depicts a flowchart of example processing at a server for a failure monitor, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

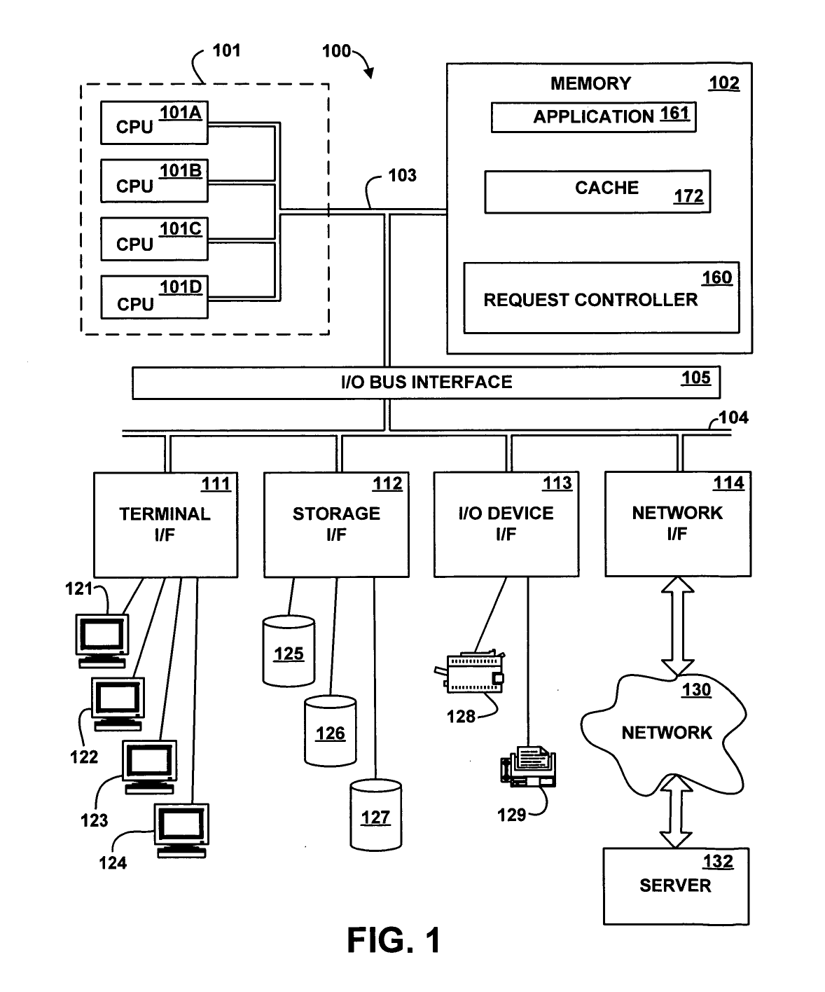

Referring to the Drawings, wherein like numbers denote like parts throughout the several views, FIG. 1 depicts a high-level block diagram representation of a client computer system 100 connected via a network 130 to a server 132, according to an embodiment of the present invention. In an embodiment, the client computer system 100 may be a gateway. The terms “computer system,” “server,” and “client,” are used for convenience only, any appropriate electronic devices may be used, in various embodiments the computer system 100 may operate as either a client or a server, and a computer system or electronic device that operates as a client in one context may operate as a server in another context. The major components of the client computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The client computer system 100 contains one or more general-purpose programmable central processing units (CPUs) 101A, 101B, 101C, and 101D, herein generically referred to as a processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing data and programs. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may further be distributed and associated with different CPUs or sets of CPUs, as is known in any of various so-called non-uniform memory access (NUMA) computer architectures.

The main memory 102 includes a request controller 160, an application 161, and a cache 172. Although the request controller 160, the application 161, and the cache 172 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the request controller 160, the application 161, and the cache 172 are illustrated as being contained within the main memory 102, these elements are not necessarily all completely contained in the same physical storage device at the same time. Further, although the request controller 160, the application 161, and the cache 172 are illustrated as being separate entities, in other embodiments some of them, or portions of some of them, may be packaged together.

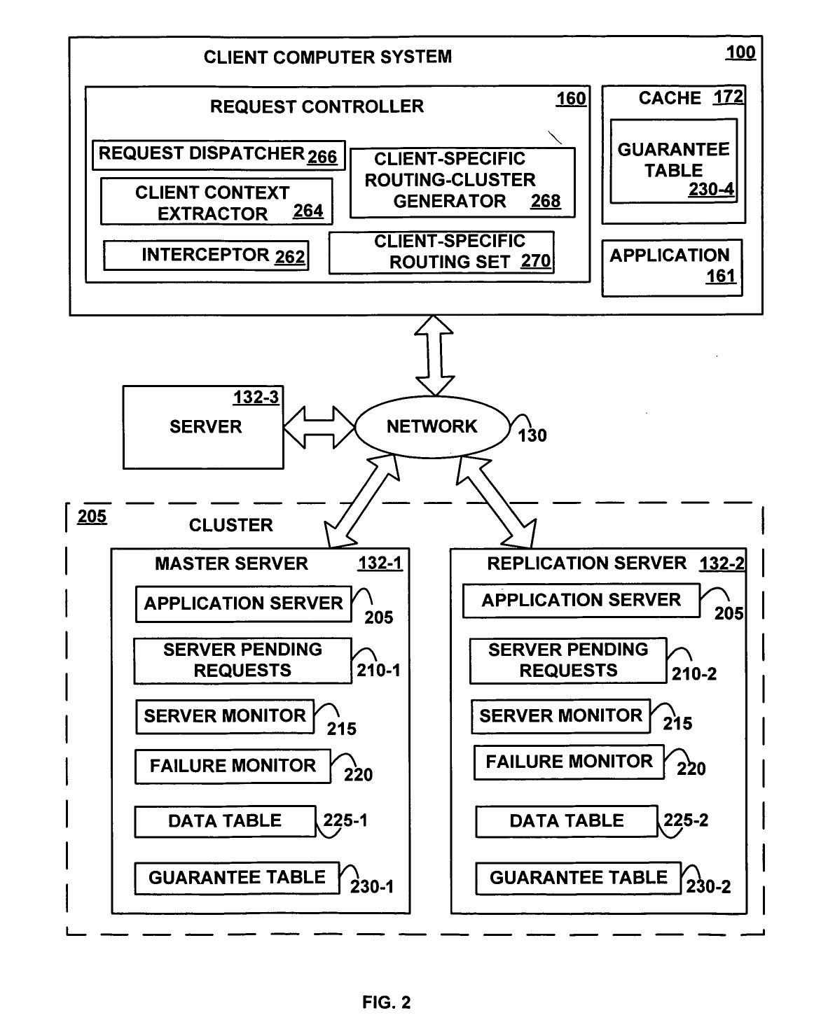

The application 161 sends requests to the request controller 160, which determines the proper server 132 to process the request and routes the requests to the proper server 132. The request controller 160 stores responses from the requests, or portions of the responses, in the cache 172. The request controller 160 is further described below with reference to FIG. 2.

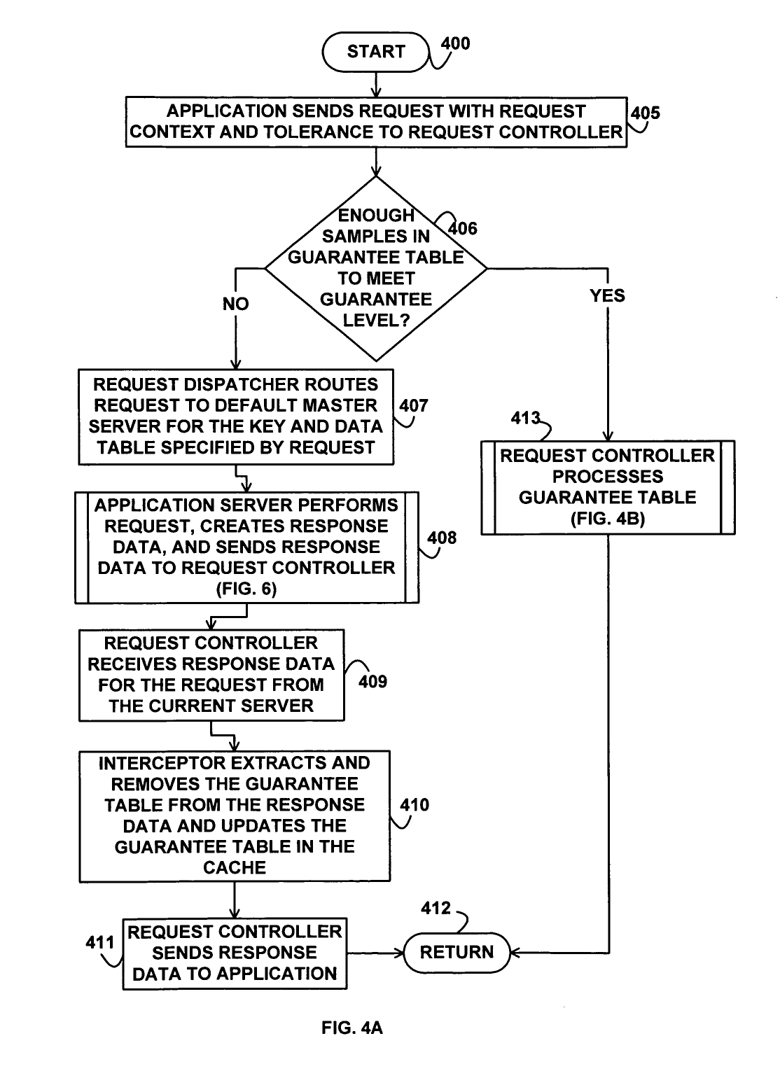

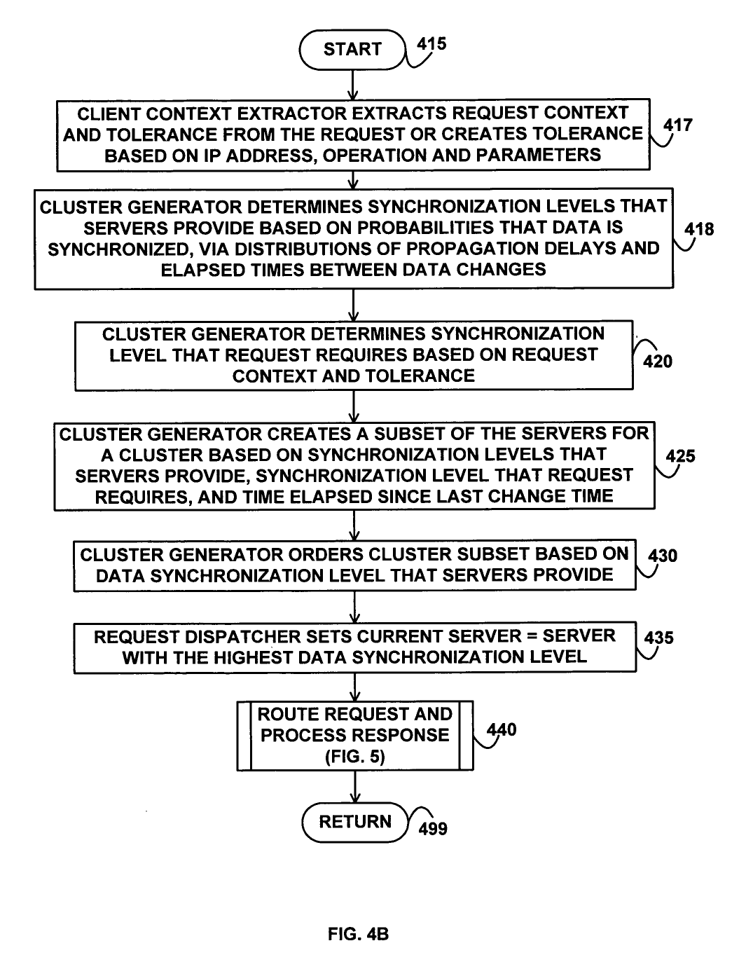

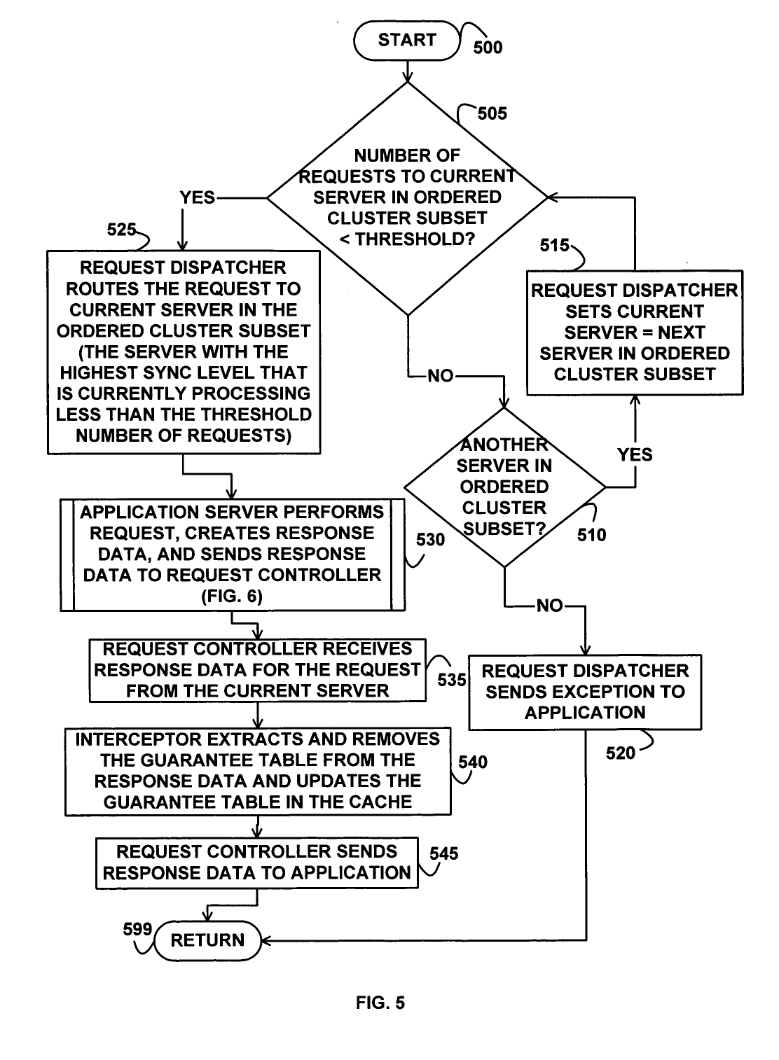

In an embodiment, the request controller 160 includes instructions stored in the memory 102 capable of executing on the processor 101 or statements capable of being interpreted by instructions executing on the processor 101 to perform the functions as further described below with reference to FIGS. 4A, 4B, and 5. In another embodiment, the request controller 160 may be implemented in microcode or firmware. In another embodiment, the request controller 160 may be implemented in hardware via logic gates and/or other appropriate hardware techniques. The application 161 may be a user application, a third-party application, an operating system, or any combination or portion thereof.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI bus, or any other appropriate bus technology.

The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127.

The I/O device interface 113 provides an interface to any of various other input/output devices or devices of other types. Two such devices, the printer 128 and the fax machine 129, are shown in the exemplary embodiment of FIG. 1, but in other embodiments many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, etc. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3×specification. In another embodiment, the network 130 may be the Internet and may support IP (Internet Protocol). In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present.

The servers 132 may include any or all of the components previously described above for the client computer system 100. The servers 132 process requests from the applications 161 that the request controller 160 routes to the servers 132. The servers 132 are further described below with reference to FIG. 2.

It should be understood that FIG. 1 is intended to depict the representative major components of the computer system 100, the network 130, and the servers 132 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements comprising the various aspects of an embodiment of the invention.

Moreover, while embodiments of the invention have and hereinafter will be described in the context of fully functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of tangible computer recordable and readable signal-bearing media, which include, but are not limited to:

(1) information permanently stored on a non-rewriteable storage medium, e.g., a read-only memory device attached to or within a computer system, such as a CD-ROM, DVD-R, or DVD+R;

(2) alterable information stored on a rewriteable storage medium, e.g., a hard disk drive (e.g., the DASD 125, 126, or 127), CD-RW, DVD-RW, DVD+RW, DVD-RAM, or diskette; or

(3) information conveyed by a communications medium, such as through a computer or a telephone network, e.g., the network 130, including wireless communications.

Such tangible signal-bearing media, when carrying machine-readable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for their use of these methods and systems. In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2 depicts a block diagram of selected components of the example system, including the client computer system 100, the network 130, and example servers 132-1, 132-2, and 132-3, according to an embodiment of the invention. The servers 132-1, 132-2, and 132-3 are examples of the servers 132 (FIG. 1). The master server 132-1 and the replication server 132-2 are organized into a cluster 205, and the server 132-3 is not in the cluster 205, but in other embodiments, any number of clusters 205 may be present, each cluster 205 may include any number of servers 132, and any number of servers 132-3 may exist outside of the cluster 205.

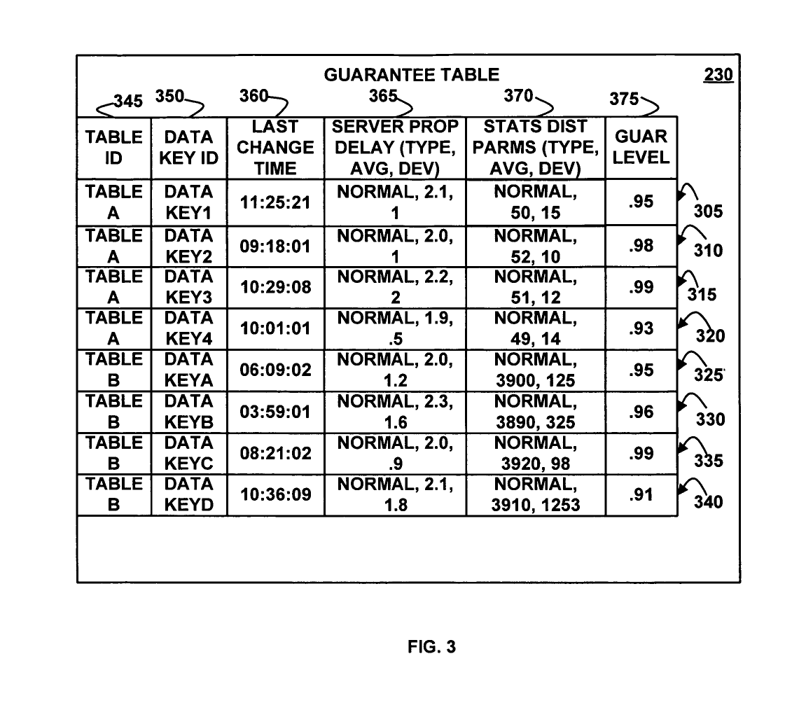

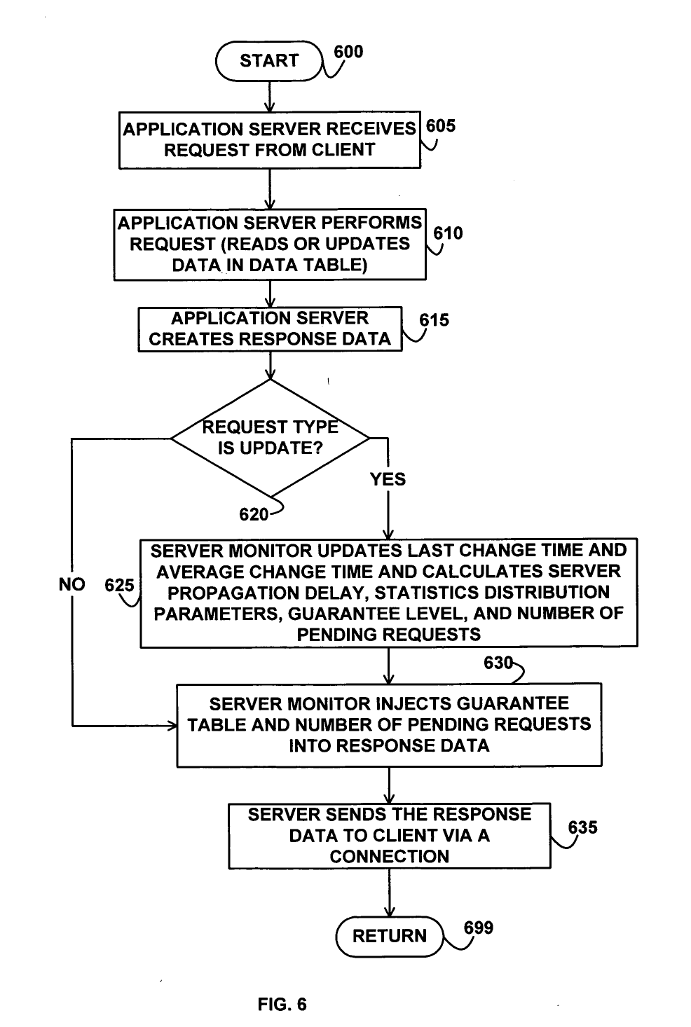

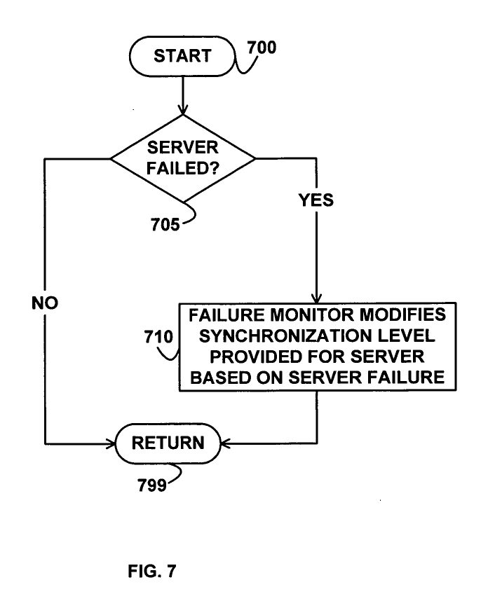

The master server 132-1 and the replication server 132-2 include an application server 205, respective server pending requests 210-1 and 210-2, a server monitor 215, a failure monitor 220, respective data tables 225-1 and 225-2, and respective guarantee tables 230-1 and 230-2. The application server 205 processes the server pending requests 210-1 and 210-2, which are requested by the application 161 and routed to the application server 205 by the request controller 160. The server monitor 215 monitors the server pending requests 210-1 and 210-2 and records information about data changes to the data tables 225-1 and 225-2, as further described below with reference to FIG. 6. The failure monitor 220 monitors errors that occur at the servers 132-1 and 132-2 or the network 130, as further described below with reference to FIG. 7. The data tables 225-1 and 225-2 include data that the server pending requests 210-1 and 210-2 access or update, and the source of the data may be client requests or data propagated from master servers, e.g., the master server 132-1. The guarantee tables 230-1 and 230-2 store the guarantee levels, propagation delays between servers, and statistics regarding the changes and propagation delays to the data tables 225-1 and 225-2, as further described below with reference to FIG. 3. The server pending requests 210-1 and 210-2 and the data tables 225-1 and 225-2 may exist in any appropriate number.

The master server 132-1 propagates changes associated with keys from the data table 225-1 to the data table 225-2 in the replication server 132-2. In an embodiment, different keys in the data tables 225-1 and 225-2 may have different master servers 132-1, and each key may have multiple master servers 132-1 and multiple replication servers 132-2. In an embodiment, each server 132 may act as the master server 132-1 for some keys, but as the replication server 132-2 for other keys. Thus, the designation of the server 132-1 as a master server and the designation of the server 132-2 as a replication server may change, depending on which key is currently of interest in the data table 225-1 or 225-2.

In an embodiment, servers that are nearby (geographically) are often grouped together into clusters 205. Although FIG. 2 illustrates a cluster 205 including both a master server 132-1 and a replication server 132-2, in another embodiment one cluster may act as a master server for some of the keys in the data table while another cluster acts as the master server for other of the keys in the data table.

In an embodiment, the application server 205, the server monitor 215, and/or the failure monitor 220 include instructions capable of being executed on a processor (analogous to the processor 101) or statements capable of being interpreted by instructions that execute on a processor. In another embodiment, the application server 205, the server monitor 215, and/or the failure monitor 220 may be implemented in hardware in lieu of or in addition to a processor-based system.

The client computer system 100 includes the request controller 160, the application 161, and the cache 172. The request controller 160 includes an interceptor 262, a client context extractor 264, a request dispatcher 266, a client-specific routing-cluster generator 268, and a client-specific routing set 270. The cache 172 includes a guarantee table 230-4, which the request controller 160 saves in the cache 172 based on data received in responses from the servers 132. The guarantee table 230-4 includes entries from all of the guarantee tables 230-1 and 230-2, which are acquired through the response stream of previous accesses to these servers.

FIG. 3 depicts a block diagram of selected components of a guarantee table 230, according to an embodiment of the invention. The guarantee table 230 generically represents the example guarantee tables 230-1, 230-2, and 230-4, each of which may include all or only a subset of the guarantee table 230. The guarantee table 230 includes records 305, 310, 315, 320, 325, 330, 335, and 340, but in other embodiments any number of records with any appropriate data may be present. Each of the records 305, 310, 315, 320, 325, 330, 335, and 340 includes a table identifier field 345, a data key identifier field 350, a last change time field 360, a server propagation delay statistics field 365 (distribution type, average propagation delay time, and deviation), a statistics distribution parameters field 370 (distribution type, average data change time, and deviation), and a guarantee level field 375, but in other embodiments more or fewer fields may be present.

The table identifier field 345 identifies a data table, such as the data tables 225-1 and 225-2. The data key identifier 350 indicates a data key in the table 345. A request from the application 161 or the server 132 previously modified data associated with the data key identifier 350 in a data table (e.g., the data table 225-1 or 225-2) identified by the table identifier 345.

In an embodiment, different keys 350 may have different master servers 132-1, and each key 350 may have multiple master servers 132-1 and multiple replication servers 132-2. In an embodiment, each server 132 may act as a master server 132-1 for some keys, but as a replication server 132-2 for other keys. Thus, the designation of the server 132-1 as a master server and the designation of the server 132-2 as a replication server may change, depending on which key is currently being replicated between the data tables 225-1 and 225-2. Hence, the synchronization level may be calculated on a per-key, per-data table, and per-server basis.

The last change time 360 indicates the date and/or time that data identified by the data key 350 was most recently changed in the table 345.

The server propagation delay statistics field 365 indicates the distribution type, average propagation delay time, and deviation to propagate data changes associated with the data key 350 between versions of the data table 345 located on different servers 132. The propagation delay time reflected in the field 365 is the time needed to propagate changes associated with the data key 350 between the data table 225-1 at the master server 132-1 and the data table 225-2 at the replication server 132-2. In response to an insert, update, or delete of a record in the table 225-1 identified by the table identifier 345 having a key 350 at the master server 132-1, the changed record is replicated from the master server 132-1 to the data tables 225-2 of all replication servers 132-2, so that all servers may see the new values for the same record with the same key. Each server 132 may have different replication delay characteristics reflected in the server propagation delay statistics field 365, depending on factors such as geographical location of the server, the type of network connection of the server, the server process capacity, and the amount of traffic on the network.

During the server propagation time delay period (the average, distribution type, and deviation for which are included in field 365), a client 100 who accesses that same record in that table 225-2 via that same key 350 in the replication server 132-2 gets a different synchronization level than a client who accesses the master server 132-1 (with respect to that changed record in that table 225-1 identified by the table 345 with that key 350) because the updated data has not yet arrived at the replication server 132-2. Thus, the master server 132-1 has the highest synchronization level for a given key 350. The synchronization level is the percentage of data that is not stale (i.e., that is up-to-date, that has been synchronized, or that has been replicated) between the master server 132-1 (where the change to the data was initially made) and the replication server 132-2.

In a normal distribution, a standard deviation is used to characterize the distribution. A standard deviation is the square root of the sum of the squares of deviations from the mean divided by the number of data points less one. Thus, in the example record 305, the server propagation delay field 365 indicates a normal distribution with an average propagation delay time of 2.1 seconds, and a standard deviation of 1 second.

The statistics distribution parameters field 370 includes the distribution type, average time between modification to the data (initiated by both client requests and server propagation), and deviation of the time between modifications to the data identified by the data key 350 in the table 345. In various embodiments, the average change time and deviation in the field 370 may be expressed in seconds, minutes, hours, days, or any other appropriate units of time.

Thus, in the example record 305, the statistics distribution parameters field 370 includes a normal distribution with an average of 50 seconds and a standard deviation of 15 seconds.

The distribution types in fields 365 and 370 may be normal distributions (also called a Gaussian distribution or a bell curve), t-distributions, linear distributions, or any statistical distributions that fits data change characteristics and server propagation delay characteristics.

The guarantee level field 375 indicates the synchronization level of data (e.g., the percentage of data that is not stale, up-to-date, synchronized or replicated between master and replication servers) associated with the key 350 in the table 345 that the application server 205 guarantees is present. For example, according to the record 305, the application server 205 guarantees that 95% (the guarantee level 375) of the data in the “table A” (the table 345) that is associated with the “data key1” (the data key 350) is not stale, is up-to-date, or is replicated across the servers 132.

FIG. 4A depicts a flowchart of example processing at the client 100 for initiating a request, according to an embodiment of the invention. Control begins at block 400. Control then continues to block 405 where the application 161 sends a request with an associated request context and optional tolerance level to the request controller 160. The request context may include a data key of a data table (e.g. the data table 225-1 or 225-2), an identifier of the data table, and an identifier of an originator (e.g., an identifier of the application 161 or a user associated with an application 161).

The tolerance level indicates the level of tolerance or intolerance that the originator, the client 100, the application 161, the request, or any combination thereof, has for stale data or for data in the data table 225-1 or 225-2 that has not been replicated between servers 132. Hence, a request that is very intolerant of stale data requires a high synchronization level. In various embodiments, the tolerance level may be expressed in absolute terms, in relative terms, as a percentage of the data in the data 225-1 or 225-2 that has been replicated, or as a percentage of the data in the data table 225-1 or 225-2 that has not been replicated. For example, a client of a banking application might be very intolerant of stale data, while a client of an inventory application might be very tolerant of stale data, but any originator may use any appropriate tolerance.

Control then continues to block 406 where the request controller 160 determines whether enough samples of data for the statistics fields 365 and 370 exist in the guarantee table 230-4 to meet the guarantee level 375 for the table 345 and key 350 to which the request is directed.

If the determination at block 406 is true, then enough samples exist, so control continues to block 413 where the request controller 160 processes the guarantee table 230-4, as further described below with reference to FIG. 4B. Control then continues to block 412 where the logic of FIG. 4A returns.

If the determination at block 406 is false, then not enough samples of data exist in the guarantee table 230-4, so control continues to block 407 where the request dispatcher 266 routes the request to the default master server 132-1 that is associated with the key and data table of the request. Control then continues to block 408 where the application server 205 at the default master server 132-1 performs the request via the appropriate data table, creates response data, and sends the response data to the request controller 160 at the client 100, as further described below with reference to FIG. 6.

Control then continues to block 409 where the request controller 160 receives the response data for the request from the master server 132-1. Control then continues to block 410 where the interceptor 262 extracts and removes the guarantee table 230 from the response and updates the guarantee table 230-4 in the cache 172 based on the extracted and removed guarantee table, which creates more samples of data in the guarantee table 230-4.

Control then continues to block 411 where the request controller 160 sends the response data, without the removed guarantee table, to the application 161 as a response to the request. Control then continues to block 412 where the logic of FIG. 4 returns.

FIG. 4B depicts a flowchart of example processing at the client 100 for initiating a request via the guarantee table 230-4, according to an embodiment of the invention. Control begins at block 415.

Control then continues to block 417 where the client context extractor 264 extracts the request context and tolerance level from the request. If the request does not contain a tolerance level, the client context extractor 264 extracts the client's IP (Internet Protocol) or other network address, the requested operation, and operation parameters from the request and calculates the client's tolerance for stale data based on the extracted information. For example, a client identified by a network address who retrieves data may be more tolerant of stale data than clients who update data, and clients who buy a small volume of products may be more tolerant of stale data than clients who buy a large volume of products.

Control then continues to block 418 where the cluster generator 268 determines the data synchronization levels that the servers 132 provide based on the guarantee table 230-4 in the cache 172. The data in the guarantee table 230-4 in the cache 172 that the cluster generator 268 uses to determine the synchronization levels arrived from the server 132 in responses to previous requests.

To calculate the synchronization levels that the servers 132 provide, the cluster generator 268 calculates the probabilities P(x) of the client 100 receiving records from replication servers 132-2 that are synchronized (i.e., that are not stale) with the associated master server 132-1 based on the client elapsed time as:
P(x)=exp[−(x*mu)ˆ2/(2*sigmaˆ2)]/[sigma*sqrt(2*pi)], where

“exp” is the exponential function;

“sqrt” is a square root function;

“pi” is the ratio of the circumference to the diameter of a circle;

“x” is the client elapsed time (the difference between the time of the client request and the last change time 360);

“mu” is the average change time in the statistics 370 for the data change; and

“sigma” is the standard deviation in the statistics 370 of the data change.

In an embodiment, the cluster generator 268 also calculates the probabilities P(y) of the client 100 receiving records from the replication servers 132-2 that are synchronized (i.e., that are not stale) with the associated master server 132-1 based on the server propagation delay as:
P(y)=exp[−(y*mu)ˆ2/(2*sigmaˆ2)]/[sigma*sqrt(2*pi)], where

“y” is the server propagation delay, which is difference between the replication server receiving time and the master server sending time (the distribution of the server propagation delay is illustrated in field 365);

“mu” is the average (the average in field 365) of all server propagation delays for this data key 350 in the server; and

“sigma” is the deviation (the deviation in the field 365) of the replication propagation delay 365 for this data key 350 for the server.

Then the cluster generator calculates the synchronization level, for each server, that the server provides as:
server provided synchronization level=[1=P(x)]*[1−P(y)].

Control then continues to block 420 where the cluster generator 268 determines the synchronization level that the request requires based on the received request context and the received tolerance level, if any. The received request context may include the command parameters, the client address, and the target data. If the client request context includes a tolerance level, then the cluster generator 268 uses the received tolerance level for the synchronization level that the request requires. If the client request does not specify a tolerance level, then the cluster generator 268 checks the request context against rules set by a system policy. If the request context matches a system policy, then the cluster generator 268 uses the tolerance level specified by the system policy for the synchronization level that the request requires. If the request context, does not match a system policy, then the cluster generator 268 checks a database of the request originator's history of requests and uses the tolerance level used in the past for the synchronization level that the request requires, based on the requestor's past satisfaction. If no historical records exist for the requestor, the cluster generator 268 uses a system default for the synchronization level that the request requires.

Control then continues to block 425 where the cluster generator 268 selects a subset of the servers 132 in the cluster 205 based on the synchronization level that the each of the servers provides (determined at block 418), the synchronization level that the request requires (determined at block 420), and the time elapsed since the last change time 360. In an embodiment, the cluster generator 268 adds those servers to the subset of the cluster 205 that have a synchronization level greater than the synchronization level that the request requires. In another embodiment, the cluster generator 268 adds those servers to the subset of the cluster 205 that have a synchronization level greater than the synchronization level that the request requires, so long as the time elapsed since the last change time 360 is greater than the average server propagation delay.

Control then continues to block 430 where the cluster generator 268 orders the servers 132 in the subset of the cluster 205 based on the determined data synchronization level that the servers provide (calculated at block 418). For example, the cluster generator 268 places those servers with the highest synchronization levels first in the ordered cluster subset and those servers with the lowest synchronization levels last in the ordered cluster subset.

Control then continues to block 435 where the cluster generator 268 sets the current server to be the server with the highest synchronization level in the ordered cluster subset. Control then continues to block 440 where the request is routed to an appropriate server and the response is processed, as further described below with reference to FIG. 5. Control then continues to block 499 where the logic of FIG. 4B returns.

FIG. 5 depicts a flowchart of example processing at the client 100 for routing a request to a server 132 and processing a response, according to an embodiment of the invention. Control begins at block 500. Control then continues to block 505 where the request dispatcher 266 determines whether the number of requests routed to the current server 132 in the ordered cluster subset is less than a threshold.

If the determination at block 505 is false, then control continues to block 510 where the request dispatcher 266 determines whether another server 132 exists in the ordered cluster subset. If the determination at block 510 is true, then control continues to block 515 where the request dispatcher 266 sets the current server in the ordered cluster subset to be the next server in the ordered cluster subset. Control then returns to block 505, as previously described above.

If the determination at block 510 is false, then control continues to block 520 where the request dispatcher 266 sends an exception to the application 161. Control then continues to block 599 where the logic of FIG. 5 returns.

If the determination at block 505 is true, then the number of requests currently being processed by the current server in the ordered cluster subset is less than a threshold, so control continues to block 525 where the request dispatcher 266 routes or sends the request to the current server in the ordered cluster subset, which is the server with the highest synchronization level in the ordered cluster subset that also is currently processing less than the threshold number of requests. Control then continues to block 530 where the application server 205 at the current selected server performs the request, creates response data, and sends the response data to the request controller 160 at the client 100, as further described below with reference to FIG. 6.

Control then continues to block 535 where the request controller 160 receives response data for the request from the current server in the ordered server subset 205. Control then continues to block 540 where the interceptor 262 extracts and removes the guarantee table 230 from the response and updates the guarantee table 230-4 in the cache 172 based on the extracted and removed guarantee table. Thus, the request controller 160 receives the data (data in the fields of the guarantee table 230-4) necessary to perform the synchronization calculations of block 418 (FIG. 4B) for subsequent requests in the responses to previous requests from the servers 132.

Control then continues to block 545 where the request controller 160 sends the response data, without the removed guarantee table, to the application 161. Control then continues to block 599 where the logic of FIG. 5 returns.

FIG. 6 depicts a flowchart of example processing at a server 132 for processing a request, according to an embodiment of the invention. Control begins at block 600. Control then continues to block 605 where the application server 205 receives a request from a client 100 or from another server. Control then continues to block 610 where the application server 205 performs the request, e.g. reads or updates data in the data table 225-1 or 225-2 or any other appropriate request. Control then continues to block 615 where the application server 205 creates response data for the request. Control then continues to block 620 where the server monitor 215 determines whether the type of the request is an update or change to the data table 225-1 or 225-2.

If the determination at block 620 is true, then control continues to block 625 where the server monitor 215 updates the last change time 360 and average change time (in the statistics distribution parameters 370) and calculates the server propagation delay statistics 365, the statistics distribution parameters 370, and the guarantee level 375 in the guarantee table 230, e.g., in the guarantee table 230-1 or 230-2. In an embodiment, the server monitor 215 calculates the guarantee level 375 as: 1—(time of the request—last change time 360)/(average change time). In an embodiment, the server monitor 215 then adjusts the calculated guarantee level 375 via the statistics distribution parameters 370. In an embodiment, the server monitor 215 then adjusts the calculated guarantee level 375 via the server propagation delay 365. The server monitor 215 further updates the number of pending requests (210-1 or 210-2) at the server 132.

Control then continues to block 630 where the server monitor 215 injects the guarantee table 230 and the number of pending requests into the response data for the request. Control then continues to block 635 where the server 132 sends the response data to the client 100 via a connection over the network 130. Control then continues to block 699 where the logic of FIG. 6 returns.

If the determination at block 620 is false, then control continues to block 630, as previously described above.

FIG. 7 depicts a flowchart of example processing for a failure monitor 220 at a server 132, according to an embodiment of the invention. Control begins at block 700. Control then continues to block 705 where the failure monitor 220 determines whether a server 132 has encountered an error. If the determination at block 705 is true, then control continues to block 710 where the failure monitor 220 modifies the guarantee level 375 provided by the server for all tables 345 at the server based on the server error. For example, the failure monitor 220 changes the guarantee level 375 to zero if the server 132 has encountered an unrecoverable error that prevents the server 132 from synchronizing data. Control then continues to block 799 where the logic of FIG. 7 returns.

If the determination at block 705 is false, then control continues to block 799 where the logic of FIG. 7 returns.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of the invention. But, the invention may be practiced without these specific details. In other instances, well-known circuits, structures, and techniques have not been shown in detail in order not to obscure the invention.

What is claimed is:

1. A method comprising:
determining a plurality of provided synchronization levels that a plurality of servers provide;
determining a required synchronization level that a request requires;
selecting one of the plurality of servers based on the plurality of provided synchronization levels and the required synchronization level; and
routing the request to the one of the plurality of servers.

2. The method of claim 1, wherein the selecting further comprises:
selecting a subset of the plurality of servers based on the required synchronization level and the plurality of provided synchronization levels; and
ordering the subset based on the provided synchronization levels.

3. The method of claim 2, wherein the selecting further comprises:
selecting the one of the plurality of servers with a highest synchronization level in the subset.

4. The method of claim 3, wherein the selecting further comprises:
selecting the one of the plurality of servers that is processing less than a threshold number of requests.

5. The method of claim 1, wherein the determining the plurality of provided synchronization levels further comprises:
determining the plurality of provided synchronization levels based on distributions of propagation time delays of data changes between the servers, wherein the data changes are associated with a key, and wherein the request specifies the key.

6. The method of claim 5, wherein the determining the plurality of provided synchronization levels further comprises:
calculating a plurality of probabilities that the data changes are synchronized between the servers based on the distributions of the propagation time delays.

7. The method of claim 1, wherein the determining the plurality of provided synchronization levels further comprises:
determining the plurality of provided synchronization levels based on distributions of elapsed times between data changes, wherein the data changes are associated with a key, and wherein the request specifies the key.

8. The method of claim 7, wherein the determining the plurality of provided synchronization levels further comprises:
calculating a plurality of probabilities that the data changes are synchronized between the servers based on the distributions of the elapsed times between the data changes.

9. The method of claim 1, wherein the determining the plurality of provided synchronization levels further comprises:
determining the plurality of provided synchronization levels based on first distributions of propagation time delays of data changes between the servers, and based on second distributions of elapsed times between the data changes at a master server, wherein the data changes are associated with a key, and wherein the request specifies the key.

10. A signal-bearing medium encoded with instructions, wherein the instructions when executed comprise:
determining a plurality of provided synchronization levels that a plurality of servers provide, wherein the determining further comprises calculating a plurality of probabilities that data changes are synchronized between the servers;
determining a required synchronization level that a request requires;
selecting one of the plurality of servers based on the plurality of provided synchronization levels and the required synchronization level; and
routing the request to the one of the plurality of servers.

11. The signal-bearing medium of claim 10, wherein the selecting further comprises:
selecting a subset of the plurality of servers based on the required synchronization level and the plurality of provided synchronization levels;
ordering the subset based on the provided synchronization levels;
selecting the one of the plurality of servers with a highest synchronization level in the subset; and
selecting the one of the plurality of servers that is processing less than a threshold number of requests.

12. The signal-bearing medium of claim 10, wherein the determining the plurality of provided synchronization levels further comprises:
determining the plurality of provided synchronization levels based on distributions of propagation time delays of data changes between the servers, wherein the data changes are associated with a key, and wherein the request specifies the key.

13. The signal-bearing medium of claim 12, wherein the determining the plurality of provided synchronization levels further comprises:
calculating the plurality of probabilities that the data changes are synchronized between the servers based on the distributions of the propagation time delays.

14. The signal-bearing medium of claim 10, wherein the determining the plurality of provided synchronization levels further comprises:
determining the plurality of provided synchronization levels based on distributions of elapsed times between data changes, wherein the data changes are associated with a key, and wherein the request specifies the key.

15. The signal-bearing medium of claim 14, wherein the determining the plurality of provided synchronization levels further comprises:
calculating the plurality of probabilities that the data changes are synchronized between the servers based on the distributions of the elapsed times between the data changes.

16. The signal-bearing medium of claim 10, wherein the determining the plurality of provided synchronization levels further comprises:
determining the plurality of provided synchronization levels based on first distributions of propagation time delays of data changes between the servers, and based on second distributions of elapsed times between the data changes, wherein the data changes are associated with a key, and wherein the request specifies the key.

17. A method for configuring a computer, comprising:
configuring the computer to determine a plurality of provided synchronization levels that a plurality of servers provide, wherein the determining further comprises calculating a plurality of probabilities that data changes are synchronized between the servers based on distributions received from the plurality of servers;
configuring the computer to determine a required synchronization level that a request requires;
configuring the computer to select one of the plurality of servers based on the plurality of provided synchronization levels and the required synchronization level; and
configuring the computer to route the request to the one of the plurality of servers.

18. The method of claim 17, wherein the configuring the computer to determine the plurality of provided synchronization levels further comprises:
configuring the computer to determine the plurality of provided synchronization levels based on the distributions, wherein the distributions comprise propagation time delays of data changes between the servers, wherein the data changes are associated with a key, and wherein the request specifies the key.

19. The method of claim 17, wherein the configuring the computer to determine the plurality of provided synchronization levels further comprises:
configuring the computer to determine the plurality of provided synchronization levels based on the distributions, wherein the distributions comprise elapsed times between data changes, wherein the data changes are associated with a key, and wherein the request specifies the key.

20. The method of claim 17, wherein the distributions comprise:
first distributions of propagation time delays of data changes between the servers; and
second distributions of elapsed times between the data changes, wherein the data changes are associated with a key, and wherein the request specifies the key.
